(19) United States
(12) Patent Application Publication
(10) Pub. No.: US 2022/0290000 A1
(43) Pub. Date: Sep. 15, 2022

(54) POWDER COATING HAVING ULTRA-HIGH WEATHER-RESISTANT AND MATTING EFFECTS

(71) Applicant: Tiger New Surface Materials (Suzhou) Co., Ltd., Suzhou (CN)

(72) Inventors: Zhicheng WANG, Qingyuan (CN); Zhenyu MI, Qingyuan (CN)

(21) Appl. No.: 17/826,208

(22) Filed: May 27, 2022

Related U.S. Application Data
(63) Continuation-in-part of application No. PCT/CN2020/127331, filed on Nov. 7, 2020.

(30) Foreign Application Priority Data
Nov. 29, 2019 (CN) 201911196823.5

(51) Int. Cl. C09D 163/00

(52) U.S. Cl. CPC C09D 163/00

(57) ABSTRACT

A powder coating having ultra-high weather-resistant and matting effects includes a first powder coating component A and a second powder coating component B which are dry-mixed into a whole and have different curing speeds. The raw materials of the first powder coating component A include a first polyester resin and a curing agent capable of undergoing a curing reaction with the first polyester resin; raw materials of the second powder coating component B include a second polyester resin and an acrylic resin containing epoxy groups, and the acrylic resin is capable of undergoing a curing reaction with the second polyester resin; an acid value of the first polyester resin is not less than 15, and an acid value of the second polyester resin is not less than 15.

### CROSS-REFERENCE TO RELAYED APPLICATIONS

This application is a continuation-in-part of International Patent Application No. PCT/CN2020/127331 with an international filing date of Nov. 7, 2020, designating the United States, now pending, and further claims foreign priority benefits to Chinese Patent Application No. 201911196823.5 filed Nov. 29, 2019. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to the field of thermosetting powder coatings, and more particularly to a powder coating having ultra-high weather-resistant and matting effects. Decorative parts of automobiles, especially exterior accessories of high-end automobiles, have substantially been coated with powder coatings. In addition, as people pursue a variety of personalized appearances and impressions, decorative parts of various gloss ranges are required on the market, including powder coatings having weather-resistant and matting effects. However, with regard to characteristics of raw materials of the powder coatings, the matting effect is achieved usually by using matting agents such as matting wax, and these matting agents usually do not meet a requirement for weather resistance.

Therefore, to resolve the technical problem, in the existing technologies, a one-component polyester/epoxy acrylic system is usually used for outdoor weather-resistant matte products. The technical solution is as follows: A polyester resin and an acrylic resin are extruded at a time, so that a coating is microscopically uneven and matting is achieved because of incompatibility of the polyester resin and the acrylic resin and network interpenetration between molecular structures of the polyester resin and the acrylic resin during a curing reaction, thereby implementing an outdoor weather-resistant powder product with gloss of 10° or below. However, this raw material system has ordinary weather resistance, and can usually only pass a xenon lamp test for 1000 hours or below. The applicant conducted a continuous tracking test and found that after the system underwent a xenon lamp test for 1500 hours, a gloss retention of the coating did not exceed 60%, and after a xenon lamp test for 2500 hours, the gloss retention of the coating even did not exceed 30%.

For example, a conventional two-component polyester resin composition with high and low acid values for an ultra-high weather-resistant dry-mixed matte powder coating includes a polyester resin for an ultra-high weather-resistant powder coating and a low-acid-value polyester resin for an ultra-high weather-resistant powder coating. Gloss that can usually be achieved by a matting system using polyesters with different acid values falls within the range of 18−45°. Due to limitations of the system, a matte coating product with gloss of 10° or below cannot be implemented.

Existing powder coating products cannot meet dual requirements that the gloss retention remains at 90% or above while the gloss is 10° or below after the product has been resistant to a xenon lamp for at least 1500 hours.

### SUMMARY

One objective of the disclosure is to provide a powder coating having ultra-high weather-resistant and matting effects, so that a matte coating product with gloss not greater than 10° can be implemented by dry-mixing a polyester curing system with a polyester and acrylic resin curing system, and the product further has excellent ultra-high weather-resistant effects.

A powder coating having ultra-high weather-resistant and matting effects comprises a first powder coating component A and a second powder coating component B which are dry-mixed into a whole and have different curing speeds. Raw materials of the first powder coating component A comprise a first polyester resin and a curing agent capable of undergoing a curing reaction with the first polyester resin. Raw materials of the second powder coating component B comprise a second polyester resin and an acrylic resin containing epoxy groups, and the acrylic resin is capable of undergoing a curing reaction with the second polyester resin. An acid value of the first polyester resin is not less than 15, and an acid value of the second polyester resin is not less than 15.

In a class of this embodiment, the acid value of the first polyester resin and/or the acid value of the second polyester resin are/is not less than 25. Preferably, the acid value of the first polyester resin and/or the acid value of the second polyester resin are/is not less than 30. Further preferably, the acid value of the first polyester resin and/or the acid value of the second polyester resin are/is not less than 40.

In a class of this embodiment, a difference between the acid value of the first polyester resin and the acid value of the second polyester resin is not less than 10.

In a class of this embodiment, a difference between the acid value of the first polyester resin and the acid value of the second polyester resin is not less than 15.

In a class of this embodiment, the raw materials of the second powder coating component B further comprise a third polyester resin capable of undergoing a curing reaction with the acrylic resin, and an acid value of the third polyester resin is less than that of the second polyester resin.

In a class of this embodiment, the raw materials of the second powder coating component B further comprise a curing agent capable of undergoing a curing reaction with the second polyester resin and/or the third polyester resin.

In a class of this embodiment, an acid value range of the first polyester resin is 45-80, and/or an acid value range of the second polyester resin is 45-80, and/or an epoxy equivalent range of the acrylic resin is 400-700.

In a class of this embodiment, viscosity of the first polyester resin and/or the second polyester resin at 200° C. is not greater than 3000 Pas.

In a class of this embodiment, viscosity of the first polyester resin and/or the second polyester resin at 200° C. falls within the range of 1500-2500 Pas.

In a class of this embodiment, the first polyester resin is the same as the second polyester resin.

In a class of this embodiment, a ratio of weight parts of the first powder coating component A to weight parts of the second powder coating component B is between 0.2:1 and 5:1.

In a class of this embodiment, the first polyester resin accounts for no less than 40 wt. % of the first powder coating component A, and the curing agent accounts for no less than 2 wt. % of the first powder coating component A.

In a class of this embodiment, the second polyester resin accounts for no less than 40 wt. % of the second powder coating component B, and weight parts of the acrylic resin are less than those of the second polyester resin.

In a class of this embodiment, the acrylic resin accounts for no less than 40 wt. % of the second powder coating component B, and weight parts of the second polyester resin are less than those of the acrylic resin.

In a class of this embodiment, raw materials of the powder coating further comprise a leveling agent and/or a degassing agent and/or pigment and fillers. The pigments and fillers may comprise carbon black and/or barium sulfate, and certainly, other types of additives can also be added as actually required. This is not particularly limited in this application.

It should be noted that, in this patent, an epoxy equivalent is in a unit of g/eq, and an acid value is in a unit of mg KOH/g.

It should also be specifically noted that the first powder coating component A and the second powder coating component B involved in this patent are separately produced by using a known powder coating production process. The known powder coating production process usually mainly comprises processes such as blending, melt extrusion, crushing, grinding, and cyclone separation. Certainly, other known powder coating production processes can also be used. There is no specifically limited technical content on this in the disclosure.

In the disclosure, a test standard for acid value data of the polyester resin is GB/T 2895-2008, a test standard for an epoxy equivalent of the acrylic resin is GB/T 4612-2008, and a test standard for viscosity of the polyester resin at 200° C. is GB/T 22314-2008.

That the first powder coating component A and the second powder coating component B have different curing reaction speeds in the disclosure means that a difference exists between the reaction speed of the resin and the curing agent therefor in the first powder coating component A and the reaction speed of the resin and the curing agent therefor in the second powder coating component B. Specifically, the reaction speed of the resin and the curing agent therefor in the first powder coating component A is greater than that in the second powder coating component B, or less than that in the second powder coating component B. The reaction speed of the resin and the curing agent can be confirmed by a gelation time test at the same temperature. A powder coating component with a shorter gelation time indicates a higher reaction speed, and a powder coating component with a longer gelation time indicates a lower reaction speed. A test standard for the gelation time may be GB/T 16995-1997.

In the disclosure, the dry-mixed first powder coating component A and second powder coating component B are provided. A polyester curing system is specifically used as the first powder coating component A to implement high weather resistance, and a polyester and acrylic resin curing system is specifically used as the second powder coating component B to implement high weather resistance. Importantly, after the dry-mixed first powder coating component A and second powder coating component B are cured to form the coating, because curing reaction speeds of the first powder coating component A and the second powder coating component B are different and the polyester resin is incompatible with the acrylic resin, a fine smooth surface of the cured coating can be ensured, and the matte coating product with gloss not greater than 10° can be obtained. In addition, it is verified through practice that the sprayed and cured coating in the disclosure has excellent ultra-high weather-resistant effects. Specifically, after a xenon lamp test for 1500 hours, the gloss retention of the coating remains at 90% or above, which is a technical effect that a matte weather-resistant powder product in the existing technologies cannot achieve.

### DETAILED DESCRIPTION

An embodiment of the disclosure provides a powder coating having ultra-high weather-resistant and matting effects, comprising a first powder coating component A and a second powder coating component B which are dry-mixed into a whole and have different curing speeds. Raw materials of the first powder coating component A comprise a first polyester resin and a curing agent capable of undergoing a curing reaction with the first polyester resin. Raw materials of the second powder coating component B comprise a second polyester resin and an acrylic resin containing epoxy groups, and the acrylic resin is capable of undergoing a curing reaction with the second polyester resin. An acid value of the first polyester resin is not less than 15, and an acid value of the second polyester resin is not less than 15.

In this embodiment, the first powder coating component A and the second powder coating component B which are dry-mixed are provided. A polyester curing system with an acid value not less than 15 is specifically used as the first powder coating component A to implement high weather resistance, and a polyester and acrylic resin curing system with an acid value not less than 15 is specifically used as the second powder coating component B to implement high weather resistance. Importantly, after the dry-mixed first powder coating component A and second powder coating component B are cured to form the coating, because curing reaction speeds of the first powder coating component A and the second powder coating component B are different and the polyester resin is incompatible with the acrylic resin, a fine smooth surface of the cured coating can be ensured, and the matte coating product with gloss not greater than 10° can be obtained. In addition, it is verified through practice that the sprayed and cured coating in this embodiment has excellent ultra-high weather-resistant effects. Specifically, after a xenon lamp test for 1500 hours, the gloss retention of the coating remains at 90% or above, which is a technical effect that a matte weather-resistant powder product in the existing technologies cannot achieve.

Optionally, the acid value of the first polyester resin and/or the acid value of the second polyester resin are/is not less than 25. Preferably, the acid value of the first polyester resin and/or the acid value of the second polyester resin are/is not less than 30. Further preferably, the acid value of the first polyester resin and/or the acid value of the second polyester resin are/is not less than 40. In this implementation, the acid value range of the first polyester resin is 45-80, and/or the acid value range of the second polyester resin is 45-80, and/or an epoxy equivalent range of the acrylic resin is 400-700. It is verified through test that when this application is implemented, a polyester resin with a larger acid value and an acrylic resin with a lower epoxy equivalent can bring more excellent, stable and reliable weather-resistant effects. In addition, the matting effects finally achieved by the powder coating in this embodiment can be further flexibly adjusted.

In this embodiment, the following preference for a ratio of weight parts of raw materials are further provided. The curing speed can be effectively adjusted by using the preference for the ratio of weight parts of raw materials, and the matting effects finally achieved by the powder coating in this embodiment are achieved through further adjustment, comprising the following:

In a class of this embodiment, a ratio of weight parts of the first powder coating component A to weight parts of the second powder coating component B is between 0.2:1 and 5:1. Further preferably, in this implementation, the first polyester resin accounts for no less than 40 wt. % of the first powder coating component A, and the curing agent accounts for no less than 2 wt. % of the first powder coating component A.

In a class of this embodiment, in an implementation of this application, the second polyester resin accounts for no less than 40 wt. % of the second powder coating component B, the acrylic resin accounts for no more than 45 wt. % of the second powder coating component B, and weight parts of the acrylic resin are less than those of the second polyester resin. This implementation has lower raw material costs and excellent matting effects.

In a class of this embodiment, in another implementation of this application, the acrylic resin accounts for no less than 40 wt. % of the second powder coating component B, and weight parts of the second polyester resin are less than those of the acrylic resin. This implementation has more excellent weather-resistant effects, but has higher raw material costs.

In a class of this embodiment, when this application is implemented, viscosity of the first polyester resin and/or the second polyester resin at 200° C. is not greater than 3000 Pas, and viscosity of the first polyester resin and/or the second polyester resin at 200° C. falls within the range of 1500-2500 Pas. Preferably, the first polyester resin is the same as the second polyester resin, so that types of raw materials can be effectively reduced.

In another preferred solution, the first polyester resin is different from the second polyester resin, and a difference between an acid value of the first polyester resin and an acid value of the second polyester resin is not less than 10. Preferably, a difference between an acid value of the first polyester resin and an acid value of the second polyester resin is not less than 15. Through the design adjustment of the specific acid value difference between the first polyester resin and the second polyester resin, the difference between the curing reaction speeds of the first powder coating component A and the second powder coating component B can be further adjusted, so that matting effects are further improved.

In a class of this embodiment, the raw materials of the second powder coating component B further comprise a third polyester resin capable of undergoing a curing reaction with the acrylic resin, an acid value of the third polyester resin is less than that of the second polyester resin, and the raw materials of the second powder coating component B further comprise a curing agent capable of undergoing a curing reaction with the second polyester resin and/or the third polyester resin. In this embodiment, the third polyester resin curing system with a curing speed different from that of the second polyester resin is provided, which can further ensure stable and reliable matting effects of this embodiment.

To ensure coating effects and give consideration to mechanical properties of the coating in this embodiment, the applicant suggested that preferably, viscosity of the first polyester resin, the second polyester resin, and the third polyester resin should all fall within a low-viscosity range, and is generally suggested to be not greater than 3000 Pas, and preferably, not greater than 2500 Pas.

To specifically describe the technical effects of implementation of this application and the achieved technical effects, in this application, the following comparative implementation processes are elaborated:

Preferably, the powder coating having ultra-high weather-resistant and matting effects in this embodiment can be produced with reference to Table 1 below for the raw material parameter ratio in specific implementation:

TABLE 1
Weight parts of raw materials in embodiments of this application

| | | First powder | Second powder |
|---|---|---|---|
| | | coating | coating |
| Types of raw materials | Specific specification | component A | component B |
| First polyester | Carboxyl-terminated polyester | 40-80 parts | / |
| resin | resin, with an acid value not less | | |
| | than 15 mg KOH/g, commercially | | |
| | available | | |
| Second polyester | Carboxyl-terminated polyester | / | 20-80 parts, the |
| resin | resin, with an acid value not less | | same as the first |
| | than 15 mg KOH/g, commercially | | polyester resin |
| | available | | |
| Third polyester | Carboxyl-terminated polyester | / | 0-25 parts |
| resin | resin, with an acid value not less | | |
| | than 15 mg KOH/g, commercially | | |
| | available | | |
| Acrylic resin | The epoxy equivalent range is | / | 10-50 parts |
| containing epoxy | 400-700 g/eq. | | |
| groups | | | |
| Curing agent | Hydroxyalkylamide curing agent, | 2-20 parts | 0-10 parts |
| | commercially available | | |
| Leveling agent | Acrylic ester, commercially | 0-1 part | 0-1 part |
| | available | | |
| Benzoin | Commercially available | 0-1 part | 0-1 part |
| PE wax | Commercially available | 0-1 part | 0-1 part |
| Carbon black | Commercially available | 0-1 part | 0-1 part |
| Barium sulfate | Commercially available | Balance | Balance |

During specific implementation, the same carboxyl-terminated polyester resin may be selected as the second polyester resin and the first polyester resin to reduce types of raw materials, or different carboxyl-terminated polyester resins with an acid value difference not less than 10 may be selected. The first powder coating component A and the second powder coating component B are separately produced by using a known powder coating production process, and then the first powder coating component A and the second powder coating component B are dry-mixed at a weight part ratio of between 0.2:1 and 5:1, to obtain a powder coating having ultra-high weather-resistant and matting effects.

In this application, the following multiple embodiments and comparative examples are made separately according to the foregoing raw material ratio table to compare and verify technical effects:

### Embodiment 1

A raw material formula of Embodiment 1 is shown in Table 2 below.

TABLE 2
Raw material formula of Embodiment 1

| | | First powder | Second powder |
|---|---|---|---|
| | | coating | coating |
| Types of raw materials | Specific specification | component A | component B |
| First | The resin has an acid value | 60 parts | / |
| carboxyl-terminated | of 40-80 mg KOH/g, and | | |
| polyester resin | is produced from TIGER. | | |
| Second | The resin has an acid value | / | 55 parts, the |
| carboxyl-terminated | of 40-80 mg KOH/g, and | | same as the first |
| polyester resin | is produced from TIGER. | | polyester resin |
| Third | The resin has an acid value | / | / |
| carboxyl-terminated | of 18-25 mg KOH/g, and | | |
| polyester resin | is produced from TIGER. | | |
| Acrylic resin | The epoxy equivalent | / | 15 parts |
| containing epoxy | range is 400-700 g/eq, and | | |
| groups | the resin is produced from | | |
| | Anderson. | | |
| Curing agent | Hydroxyalkylamide curing | 15 parts | / |
| | agent, commercially | | |
| | available | | |
| Leveling agent | Acrylic ester, | 1 part | 1 part |
| | commercially available | | |
| Benzoin | Commercially available | 0.5 part | 0.5 part |
| Degassing agent | PE wax, commercially | 0.3 part | 0.3 part |
| | available | | |
| Carbon black | Commercially available | 1 part | 1 part |
| Barium sulfate | Commercially available | Balance | Balance |

Raw materials of the first powder coating component A and the second powder coating component B are prepared according to the formula of Table 2, the components are separately produced by using a known powder coating production process, and then the first powder coating component A and the second powder coating component B are dry-mixed at a weight part ratio of 1:1 to obtain a powder coating having ultra-high weather-resistant and matting effects.

### Embodiment 2

A raw material formula of Embodiment 2 is shown in Table 3 below.

TABLE 3
Raw material formula of Embodiment 2

| | | First powder | Second powder |
|---|---|---|---|
| | | coating | coating |
| Types of raw materials | Specific specification | component A | component B |
| First | The resin has an acid value | 50 parts | / |
| carboxyl-terminated | of 40-80 mg KOH/g, and is | | |
| polyester resin | produced from TIGER. | | |
| Second | The resin has an acid value | / | 50 parts, the |
| carboxyl-terminated | of 40-80 mg KOH/g, and is | | same as the first |
| polyester resin | produced from TIGER. | | polyester resin |
| Third | The resin has an acid value | / | 10 parts |
| carboxyl-terminated | of 18-25 mg KOH/g, and is | | |
| polyester resin | produced from TIGER. | | |
| Acrylic resin containing | The epoxy equivalent range | / | 10 parts |
| epoxy groups | is 400-700 g/eq, and the | | |
| | resin is produced from | | |
| | Anderson. | | |
| Curing agent | Hydroxyalkylamide curing | 20 parts | 5 parts |
| | agent, commercially | | |
| | available | | |
| Leveling agent | Acrylic ester, commercially | 1 part | 1 part |
| | available | | |
| Benzoin | Commercially available | 0.5 part | 0.5 part |
| Degassing agent | PE wax, commercially | 0.3 part | 0.3 part |
| | available | | |
| Carbon black | Commercially available | 1 part | 1 part |
| Barium sulfate | Commercially available | Balance | Balance |

Raw materials of the first powder coating component A and the second powder coating component B are prepared according to the formula of Table 3, the components are separately produced by using a known powder coating production process, and then the first powder coating component A and the second powder coating component B are dry-mixed at a weight part ratio of 0.5:1 to obtain a powder coating having ultra-high weather-resistant and matting effects.

### Embodiment 3

A raw material formula of Embodiment 3 is shown in Table 4 below.

TABLE 4
Raw material formula of Embodiment 3

| | | First powder | Second powder |
|---|---|---|---|
| | | coating | coating |
| Types of raw materials | Specific specification | component A | component B |
| First | The resin has an acid value | 40 parts | / |
| carboxyl-terminated | of 40-80 mg KOH/g, and is | | |
| polyester resin | produced from TIGER. | | |
| Second | The resin has an acid value | / | 80 parts, the |
| carboxyl-terminated | of 40-80 mg KOH/g, and is | | same as the first |
| polyester resin | produced from TIGER. | | polyester resin |
| Third | The resin has an acid value | / | / |
| carboxyl-terminated | of 18-25 mg KOH/g, and is | | |
| polyester resin | produced from TIGER. | | |
| Acrylic resin | The epoxy equivalent range | / | 20 parts |
| containing epoxy | is 400-700 g/eq, and the | | |
| groups | resin is produced from | | |
| | Anderson. | | |
| Curing agent | Hydroxyalkylamide curing | 10 parts | / |
| | agent, commercially | | |
| | available | | |
| Leveling agent | Acrylic ester, commercially | 1 part | / |
| | available | | |
| Benzoin | Commercially available | 0.5 part | / |
| Degassing agent | PE wax, commercially | 0.3 part | / |
| | available | | |
| Carbon black | Commercially available | 1 part | / |
| Barium sulfate | Commercially available | Balance | / |

Raw materials of the first powder coating component A and the second powder coating component B are prepared according to the formula of Table 4, the components are separately produced by using a known powder coating production process, and then the first powder coating component A and the second powder coating component B are dry-mixed at a weight part ratio of 2:1 to obtain a powder coating having ultra-high weather-resistant and matting effects.

### Embodiment 4

A raw material formula of Embodiment 4 is shown in Table 5 below.

TABLE 5
Raw material formula of Embodiment 4

| | | First powder | Second powder |
|---|---|---|---|
| | | coating | coating |
| Types of raw materials | Specific specification | component A | component B |
| First | The resin has an acid | 70 parts | / |
| carboxyl-terminated | value of 40-80 mg | | |
| polyester resin | KOH/g, and is produced | | |
| | from TIGER. | | |
| Second | The resin has an acid | / | 40 parts, the |
| carboxyl-terminated | value of 40-80 mg | | same as the first |
| polyester resin | KOH/g, and is produced | | polyester resin |
| | from TIGER. | | |
| Third | The resin has an acid | / | 15 parts |
| carboxyl-terminated | value of 18-25 mg | | |
| polyester resin | KOH/g, and is produced | | |
| | from TIGER. | | |
| Acrylic resin | The epoxy equivalent | / | 20 parts |
| containing epoxy | range is 400-700 g/eq, | | |
| groups | and the resin is produced | | |
| | from Anderson. | | |
| Curing agent | Hydroxyalkylamide | 18 parts | 8 parts |
| | curing agent, | | |
| | commercially available | | |
| Leveling agent | Acrylic ester, | 1 part | 1 part |
| | commercially available | | |
| Benzoin | Commercially available | 0.5 part | 0.5 part |
| Degassing agent | PE wax, commercially | 0.3 part | 0.3 part |
| | available | | |
| Carbon black | Commercially available | 1 part | 1 part |
| Barium sulfate | Commercially available | Balance | Balance |

Raw materials of the first powder coating component A and the second powder coating component B are prepared according to the formula of Table 5, the components are separately produced by using a known powder coating production process, and then the first powder coating component A and the second powder coating component B are dry-mixed at a weight part ratio of 0.2:1 to obtain a powder coating having ultra-high weather-resistant and matting effects.

### Embodiment 5

A raw material formula of Embodiment 5 is shown in Table 6 below.

TABLE 6
Raw material formula of Embodiment 5

| | | First powder | Second powder |
|---|---|---|---|
| | | coating | coating |
| Types of raw materials | Specific specification | component A | component B |
| First | The resin has an acid value | 80 parts | / |
| carboxyl-terminated | of 40-80 mg KOH/g, and is | | |
| polyester resin | produced from TIGER. | | |
| Second | The resin has an acid value | / | 80 parts; the resin is |
| carboxyl-terminated | of 40-80 mg KOH/g, and is | | different from the |
| polyester resin | produced from TIGER. | | first polyester resin, |
| | | | and the difference |
| | | | between the acid |
| | | | value of the resin and |
| | | | the acid value of the |
| | | | first polyester resin is |
| | | | not less than 10. |
| Third | The resin has an acid value | / | / |
| carboxyl-terminated | of 18-25 mg KOH/g, and is | | |
| polyester resin | produced from TIGER. | | |
| Acrylic resin | The epoxy equivalent range | / | 15 parts |
| containing epoxy | is 400-700 g/eq, and the | | |
| groups | resin is produced from | | |
| | Anderson. | | |
| Curing agent | Hydroxyalkylamide curing | 20 parts | / |
| | agent, commercially | | |
| | available | | |
| Leveling agent | Acrylic ester, commercially | / | 1 part |
| | available | | |
| Benzoin | Commercially available | / | 0.5 part |
| Degassing agent | PE wax, commercially | / | 0.3 part |
| | available | | |
| Carbon black | Commercially available | / | 1 part |
| Barium sulfate | Commercially available | / | Balance |

Raw materials of the first powder coating component A and the second powder coating component B are prepared according to the formula of Table 6, the components are separately produced by using a known powder coating production process, and then the first powder coating component A and the second powder coating component B are dry-mixed at a weight part ratio of 0.8:1 to obtain a powder coating having ultra-high weather-resistant and matting effects.

### Embodiment 6

A raw material formula of Embodiment 6 is shown in Table 7 below.

TABLE 7
Raw material formula of Embodiment 6

| | | First powder | Second powder |
|---|---|---|---|
| | | coating | coating |
| Types of raw materials | Specific specification | component A | component B |
| First | The resin has an acid value of | 80 parts | / |
| carboxyl-terminated | 30-40 mg KOH/g, and is | | |
| polyester resin | produced from TIGER. | | |
| Second | The resin has an acid value of | / | 80 parts |
| carboxyl-terminated | 40-80 mg KOH/g, and is | | |
| polyester resin | produced from TIGER. | | |
| Third | The resin has an acid value of | / | / |
| carboxyl-terminated | 18-25 mg KOH/g, and is | | |
| polyester resin | produced from TIGER. | | |
| Acrylic resin | The epoxy equivalent range is | / | 15 parts |
| containing epoxy | 400-700 g/eq, and the resin is | | |
| groups | produced from Anderson. | | |
| Curing agent | Hydroxyalkylamide curing agent, | 20 parts | / |
| | commercially available | | |
| Leveling agent | Acrylic ester, commercially | / | 1 part |
| | available | | |
| Benzoin | Commercially available | / | 0.5 part |
| Degassing agent | PE wax, commercially available | / | 0.3 part |
| Carbon black | Commercially available | / | 1 part |
| Barium sulfate | Commercially available | / | Balance |

Raw materials of the first powder coating component A and the second powder coating component B are prepared according to the formula of Table 7, the components are separately produced by using a known powder coating production process, and then the first powder coating component A and the second powder coating component B are dry-mixed at a weight part ratio of 1:1 to obtain a powder coating having ultra-high weather-resistant and matting effects.

### Embodiment 7

A raw material formula of Embodiment 7 is shown in Table 8 below.

TABLE 8
Raw material formula of Embodiment 7

| | | First powder | Second powder |
|---|---|---|---|
| | | coating | coating |
| Types of raw materials | Specific specification | component A | component B |
| First | The resin has an acid | 80 parts | / |
| carboxyl-terminated | value of 25-30 mg | | |
| polyester resin | KOH/g, and is | | |
| | commercially available. | | |
| Second | The resin has an acid | / | 50 parts |
| carboxyl-terminated | value of 15-25 mg | | |
| polyester resin | KOH/g, and is | | |
| | commercially available. | | |
| Third | The resin has an acid | / | / |
| carboxyl-terminated | value of 18-25 mg | | |
| polyester resin | KOH/g, and is produced | | |
| | from TIGER. | | |
| Acrylic resin | The epoxy equivalent | / | 45 parts |
| containing epoxy | range is 400-700 g/eq, | | |
| groups | and the resin is produced | | |
| | from Anderson. | | |
| Curing agent | Hydroxyalkylamide | 20 parts | / |
| | curing agent, | | |
| | commercially available | | |
| Leveling agent | Acrylic ester, | / | 1 part |
| | commercially available | | |
| Benzoin | Commercially available | / | 0.5 part |
| Degassing agent | PE wax, commercially | / | 0.3 part |
| | available | | |
| Carbon black | Commercially available | / | 1 part |
| Barium sulfate | Commercially available | / | Balance |

Raw materials of the first powder coating component A and the second powder coating component B are prepared according to the formula of Table 8, the components are separately produced by using a known powder coating production process, and then the first powder coating component A and the second powder coating component B are dry-mixed at a weight part ratio of 3:1 to obtain a powder coating having ultra-high weather-resistant and matting effects.

### Embodiment 8

A raw material formula of Embodiment 8 is shown in Table 9 below.

TABLE 9
Raw material formula of Embodiment 8

| | | First powder | Second powder |
|---|---|---|---|
| | | coating | coating |
| Types of raw materials | Specific specification | component A | component B |
| First | The resin has an acid | 80 parts | / |
| carboxyl-terminated | value of 15-25 mg | | |
| polyester resin | KOH/g, and is | | |
| | commercially available. | | |
| Second | The resin has an acid | / | 45 parts, the same as the |
| carboxyl-terminated | value of 15-25 mg | | first carboxyl-terminated |
| poltester resin | KOH/g, and is | | polyester resin |
| | commercially available. | | |
| Third | The resin has an acid | / | 15 parts |
| carboxyl-terminated | value of 18-25 mg | | |
| polyester resin | KOH/g, and is produced | | |
| | from TIGER. | | |
| Acrylic resin | The epoxy equivalent | / | 30 parts |
| containing epoxy | range is 400-700 g/eq, | | |
| groups | and the resin is produced | | |
| | from Anderson. | | |
| Curing agent | Hydroxyalkylamide | 20 parts | 4 parts; this curing agent |
| | curing agent, | | can be cured with the |
| | commercially available | | second carboxyl-terminated |
| | | | polyester resin and the third |
| | | | carboxyl-terminated |
| | | | polyester resin |
| | | | simultaneously. |
| Leveling agent | Acrylic ester, | / | 1 part |
| | commercially available | | |
| Benzoin | Commercially available | / | 0.5 part |
| Degassing agent | PE wax, commercially | / | 0.3 part |
| | available | | |
| Carbon black | Commercially available | / | 1 part |
| Barium sulfate | Commercially available | / | Balance |

Raw materials of the first powder coating component A and the second powder coating component B are prepared according to the formula of Table 9, the components are separately produced by using a known powder coating production process, and then the first powder coating component A and the second powder coating component B are dry-mixed at a weight part ratio of 1:1 to obtain a powder coating having ultra-high weather-resistant and matting effects.

### Embodiment 9

The implementation solution of Embodiment 9 is the same as that of Embodiment 1, except that in Embodiment 9, a first powder coating component A and a second powder coating component B are dry-mixed at a weight part ratio of 0.4:1 to obtain a powder coating having ultra-high weather-resistant and matting effects.

### Embodiment 10

The implementation solution of Embodiment 10 is the same as that of Embodiment 1, except that in Embodiment 10, a first powder coating component A and a second powder coating component B are dry-mixed at a weight part ratio of 0.2:1 to obtain a powder coating having ultra-high weather-resistant and matting effects.

### Embodiment 11

The implementation solution of Embodiment 11 is the same as that of Embodiment 1, except that in Embodiment 11, a first powder coating component A and a second powder coating component B are dry-mixed at a weight part ratio of 3:1 to obtain a powder coating having ultra-high weather-resistant and matting effects.

### Embodiment 12

The implementation solution of Embodiment 12 is the same as that of Embodiment 1, except that in Embodiment 12, a first powder coating component A and a second powder coating component B are dry-mixed at a weight part ratio of 5:1 to obtain a powder coating having ultra-high weather-resistant and matting effects.

Certainly, in the other implementations of this embodiment, a first powder coating component A and a second powder coating component B at other weight part ratios can also be used for dry mixing, to also achieve excellent matting and ultra-high weather-resistant technical effects. These weight part ratios should not be regarded as a specific technical feature of this application, and a person skilled in the art can make specific ratio selection as actually required.

### Comparative Example 1

A weather-resistant matting powder coating proposed by the patent No. CN101787239B is directly used in Comparative Example 1.

### Comparative Example 2

A weather-resistant matting powder coating proposed by the patent No. CN1219006C is directly used in Comparative Example 2.

### Comparative Example 3

A weather-resistant matting powder coating proposed by the patent No. CN109486373A is directly used in Comparative Example 3.

### Comparative Example 4

A weather-resistant matting powder coating proposed by the patent No. CN104046214A is directly used in Comparative Example 4.

### Comparative Example 5

A weather-resistant matting powder coating proposed by the patent No. CN103131308A is directly used in Comparative Example 5.

After the powder coatings in Embodiments 1-12 and the powder coatings in Comparative Examples 1-5 were electrostatically sprayed under the same conditions and completely cured, the applicant conducted comparative tests on the correspondingly obtained coatings. Test results are shown in Table 10 below.

TABLE 10
Comparison of technical effects between the embodiments and the comparative examples

| | | | | Gloss retention |
|---|---|---|---|---|
| | Appearance | | | after resistance to |
| | (visual | | | a xenon lamp for |
| | comparison) | Gloss (60°) | Impact resistance | 1500 hours |
| Embodiments | Flat, fine, and | 10° or below | Impact-resistant for | ≥90% |
| 1-12 | smooth | | both front and back | |
| | | | surfaces | |
| Comparative | Flat, fine, but | 10° or below | Impact-resistant for | Less than 30% |
| Example 1 | unsmooth | | both front and back | |
| | | | surfaces | |
| Comparative | Flat, fine, but | 10° or below | Impact-resistant for | Less than 30% |
| Example 2 | unsmooth | | both front and back | |
| | | | surfaces | |
| Comparative | Flat, fine, but | 10° or below | Impact-resistant for | Less than 30% |
| Example 3 | unsmooth | | both front and back | |
| | | | surfaces | |
| Comparative | Flat, fine, but | 10° or below | Impact-resistant for | Less than 30% |
| Example 4 | unsmooth | | both front and back | |
| | | | surfaces | |
| Comparative | Flat, fine, and | 18-45° | Impact-resistant for | ≥90% |
| Example 5 | smooth | | both front and back | |
| | | | surfaces | |

Note: In Table 10 above, the appearance is judged by visual comparison, a gloss test standard is ISO 2813-2014, an impact resistance test standard is ISO 6272-2-2011, a xenon lamp test standard is ISO 16474-2-2013, and a 60° test angle is used for a gloss test for the gloss retention.

In addition, through comparison of weather-resistant effects of Embodiments 1-12, it can be found that the gloss retentions in Embodiments 1-6 and Embodiments 9-12 can still remain at 90% or above after resistance to a xenon lamp for 2500 hours, indicating that a polyester resin with a larger acid value has higher weather resistance. Embodiments 2,4,5, and 8 can bring more excellent matting effects by designing the acid value difference and adding the third polyester resin curing system.

It is clear to a person skilled in the art that the disclosure is not limited to the details of the foregoing example embodiments, and the disclosure can be implemented in other specific forms without departing from the spirit or essential features of the disclosure. Therefore, the embodiments should be regarded in all respects as examples rather than as restrictive, and the scope of the disclosure is defined by the appended claims rather than the foregoing descriptions. Therefore, all changes falling within the meanings and scope of equivalent elements of the claims are included in the disclosure.

It will be obvious to those skilled in the art that changes and modifications may be made, and therefore, the aim in the appended claims is to cover all such changes and modifications.

What is claimed is:

1. A powder coating having ultra-high weather-resistant and matting effects, comprising a first powder coating component A and a second powder coating component B which are dry-mixed into a whole and have different curing speeds, wherein raw materials of the first powder coating component A comprise a first polyester resin and a curing agent capable of undergoing a curing reaction with the first polyester resin; raw materials of the second powder coating component B comprise a second polyester resin and an acrylic resin containing epoxy groups, and the acrylic resin is capable of undergoing a curing reaction with the second polyester resin; an acid value of the first polyester resin is not less than 15, and an acid value of the second polyester resin is not less than 15.

2. The powder coating of claim 1, wherein the acid value of the first polyester resin is not less than 25, and/or the acid value of the second polyester resin is not less than 25.

3. The powder coating of claim 1, wherein a difference between the acid value of the first polyester resin and the acid value of the second polyester resin is not less than 10.

4. The powder coating of claim 1, wherein the raw materials of the second powder coating component B further comprise a third polyester resin capable of undergoing a curing reaction with the acrylic resin, and an acid value of the third polyester resin is less than that of the second polyester resin.

5. The powder coating of claim 4, wherein the raw materials of the second powder coating component B further comprise a curing agent capable of undergoing a curing reaction with the second polyester resin and/or the third polyester resin.

6. The powder coating of claim 1, wherein an acid value range of the first polyester resin is 45-80, and/or an acid value range of the second polyester resin is 45-80, and/or an epoxy equivalent range of the acrylic resin is 400-700.

7. The powder coating of claim 1, wherein a viscosity of the first polyester resin and/or the second polyester resin at 200° C. is not greater than 3000 Pas.

8. The powder coating of claim 1, wherein a viscosity of the first polyester resin and/or the second polyester resin at 200° C. falls within the range of 1500-2500 Pas.

9. The powder coating of claim 1, wherein the first polyester resin is the same as the second polyester resin.

10. The powder coating of claim 1, wherein a ratio of weight parts of the first powder coating component A to weight parts of the second powder coating component B is between 0.2:1 and 5:1.

11. The powder coating of claim 1, wherein the first polyester resin accounts for no less than 40 wt. % of the first powder coating component A, and the curing agent accounts for no less than 2 wt. % of the first powder coating component A.

12. The powder coating of claim 1, wherein the second polyester resin accounts for no less than 40 wt. % of the second powder coating component B, and weight parts of the acrylic resin are less than those of the second polyester resin.

13. The powder coating of claim 1, wherein the acrylic resin accounts for no less than 40 wt. % of the second powder coating component B, and weight parts of the second polyester resin are less than those of the acrylic resin.
